(19) United States
(12) Patent Application Publication
(10) Pub. No.: US 2004/0102928 A1
(43) Pub. Date: May 27, 2004

(54) Method, system, and storage medium for building and maintaining a remote monitoring and diagnostics knowledge base

(75) Inventors: Paul Edward Cuddihy, Ballston Lake, NY (US); Jeremiah Francis Donoghue, Ballston Lake, NY (US); Steven Hector Azzaro, Schenectady, NY (US); Timothy Lee Johnson, Niskayuna, NY (US)

Correspondence Address: General Electric Company, CRD Patent Docket Rm 4A59, P.O. Box 8, Bldg. K-1, Schenectady, NY, 12301, US

(73) Assignee: General Electric Company

(21) Appl. No.: 10/303,943

(22) Filed: Nov. 26, 2002

(51) Int. Cl. G06F 15/00

(52) U.S. Cl. 702/188

(57) ABSTRACT

An exemplary embodiment of the invention relates to a method, system, and storage medium for building and maintaining a remote monitoring and diagnostics knowledge base via an alert fusion system. The method comprises receiving at least one alert relating to a condition detected on field equipment being remotely monitored. The method further comprises processing the alert which includes evaluating a severity level, and if a severity threshold is reached, generating a summary alert. The summary alert is transmitted to an end user at a remote client. The invention also includes a system and a storage medium for implementing the invention.

### BACKGROUND OF THE INVENTION

The present invention relates to facilitated knowledge management for trend performance analysis and in particular to a method, system, and storage medium for building and maintaining a remote monitoring and diagnostics knowledge base.

Remote equipment monitoring processes are well-known tool and enable engineers, repair technicians, and other specialists to collect various types of performance information, quality control data, and usage statistics relating to geographically remote machinery. These activities are performed electronically over a computer network. Advanced networking technologies now allow many of these activities to occur in near real time. For example, by associating an IP address with a specific piece of equipment, a web-enabled remote computer can view current performance data.

Remote monitoring and diagnostics call centers have attempted to keep their knowledge-based systems up to date through the use of review boards which periodically update the knowledge. Many forms of data can be collected to seed these review boards so that decisions about organizing the knowledge base can be made. Examples of data include: feedback from system users about past system performance, paretos or detailed summaries of the most common failures, paretos or detailed summaries of the most commonly mishandled problems, screen dumps or videos of engineers' screens as they solve problems, etc. The review boards, typically comprising experts in the equipment being monitored and in the business processes involved in equipment monitoring and diagnostics, evaluate the seed data and attempt to update the knowledge in the knowledge base. One of the disadvantages of this process is that the volume of data received and processed requires substantial human intervention, is costly to collect, and is prone to errors. Other problems are encountered when the data neither precisely nor accurately captures what the engineers in the call center or out in the field are actually doing to diagnose and resolve the problem.

The popularity of knowledge-based systems continues to grow as corporations look to capture and institutionalize the expertise of their employees. It is therefore desirable to provide a method and system for facilitating knowledge capture and maintenance for remote monitoring and diagnostics systems.

### SUMMARY

An exemplary embodiment of the invention relates to a method, system, and storage medium for building and maintaining a remote monitoring and diagnostics knowledge base via an alert fusion system. The method comprises receiving at least one alert relating to a condition detected on equipment being remotely monitored. The method further comprises processing the alert which includes evaluating a severity level, and if a severity threshold is reached, generating a summary alert. The summary alert is transmitted to an end user at a remote client. The invention also includes a system and a storage medium for implementing the invention.

Further aspects of the invention are disclosed herein. The above discussed and other features and advantages of the invention will be appreciated and understood by those skilled in the art from the following detailed description and drawings.

### BRIEF DESCRIPTION OF THE DRAWINGS

Referring to the exemplary drawings wherein like elements are numbered alike in the several FIGURES:

FIG. 1 is a block diagram of an exemplary system for building and maintaining a remote monitoring and diagnostics knowledge base;

FIG. 2 is a flowchart of a process for building and maintaining a remote monitoring and diagnostics knowledge base in an exemplary embodiment;

FIG. 3 is a user interface screen displaying a summary alert and details for a condition detected in an exemplary embodiment;

FIG. 4 is a user interface screen displaying fusion history information relating to equipment being monitored in an exemplary embodiment; and

FIG. 5 is a user interface screen displaying suggested troubleshooting instructions for equipment being monitored in an exemplary embodiment.

### DETAILED DESCRIPTION OF THE INVENTION

In an exemplary embodiment of the invention a system 100 for building and maintaining a remote monitoring and diagnostics knowledge base is described. System 100 may be manifested in the context of various types of industries such as power, utilities, communications, transportation, chemical or mechanical processing plants, or any system that generates sensor data where it is desirable to monitor or diagnose system behavior.

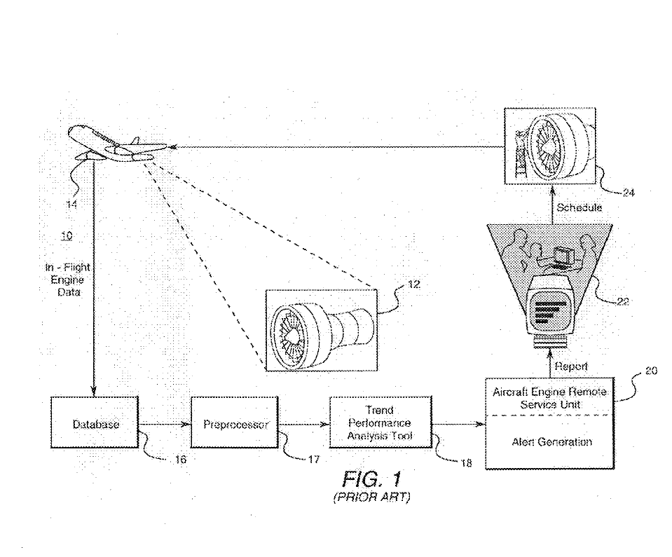

The simplified system 100 of FIG. 1 includes field equipment 102 and remote client 106. Remote client 106 comprises an Internet-enabled computer processing device such as a general-purpose desktop, laptop, or other similar processing device. An engineer or individual designated to remotely monitor field equipment 102 accesses remote client 106 which is in communication with field equipment 102 via a communications link or network and an Internet service provider. Field equipment 102 devices may comprise any suitable machinery such as industrial machines, telecommunications equipment, computer systems, medical instruments, and manufacturing equipment. For example, field equipment 102 may be a generator in which fault conditions, power outages, and battery power are monitored. Although a single remote client 106 is shown in FIG. 1, it will be understood that any number of remote clients may be included in system 100 in order to realize the advantages of the invention. The engineer (also referred to as end user) receives summary alerts via remote client 106 and evaluates them, taking appropriate corrective action if necessary.

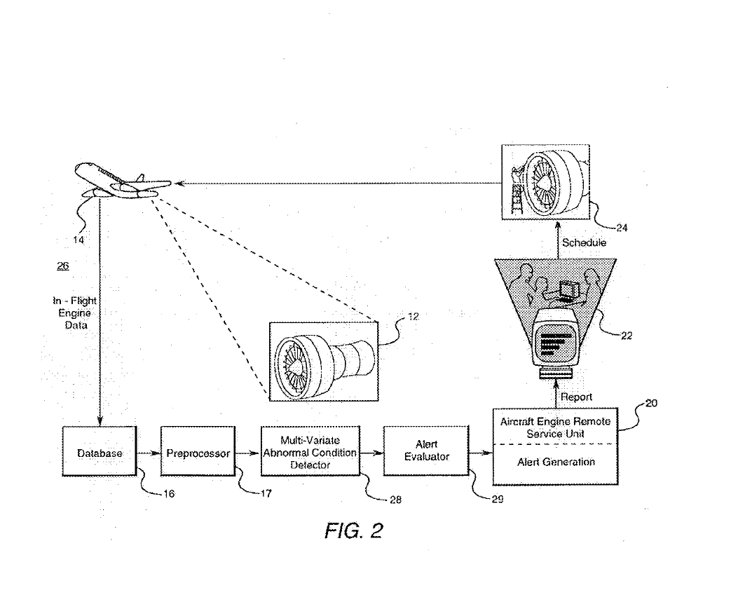

Also included in system 100 is alert fusion system 110 which comprises various integrated components for building and maintaining a knowledge base. Alert fusion system 110 includes a field equipment monitor 104 (also referred to as ‘monitor’). An internal processor of monitor 104 is provided for allowing monitor 104 to receive signals and data outputted from field equipment 102. Monitor 104 includes sensors that receive signals or data from field equipment 102 that pertain to measurements of performance variables such as temperature, speed, compression, and voltage, to name a few. Monitor 104 generates an alert when a specified condition is detected by a sensor. An alert refers generally to a warning that is manifested through lights, sound, or other similar type of notification. Although monitor 104 is shown as a separate physical unit from field equipment 102, it will be understood that monitor 104 may be located within, or attached to, field equipment 102. Parameters are determined for these variables such as specified ranges that define acceptable upper and lower limits for a particular field equipment device or component thereof. If a sensor detects that a value has fallen outside of the range, an alert is generated. There may be situations in which many alerts are generated before any investigative or corrective action is required. This may depend upon the specific variable being monitored and/or the severity of a value's deviation from the acceptable range, as well as other factors. Monitor 104 also receives information from alert knowledge database 126 such as policy information for when to issue an alert, parameter limits for different variables being monitored, etc. Alert knowledge database 126 stores histories of alerts relating to field equipment 102 devices so that an individual monitoring the equipment can access relevant data about how the equipment has performed in the past. For example, if a component of field equipment 102 has been exhibiting signs of diminished performance, a troubleshooter can access a host of historical information contained in past alerts that are associated with the component experiencing the difficulty. The specific alerts may be searched and retrieved from alert knowledge database 126 by data fields such as the component's identifier. This information stored in alert knowledge database 126 can be updated periodically over time as new and more advanced knowledge becomes available. This feature of alert knowledge database 126 is described in further detail in FIG. 2.

Monitor 104 sends raw data 114 and alerts 116 data to fusion module 118. Raw data 114 includes actual measurements obtained from field equipment 102, such as temperature readings, compression rates, RPMs, etc. Alerts 116 data may include the date the alert is issued, an alert identifier, the identification of the field equipment and/or component that is subject to the alert, the variable(s) detected to have deviated from the acceptable parameters set, the time of the reading, the time of the alert, and equipment location information. Fusion module 118 interfaces with monitor 104, fusion knowledge database 120, and remote client 106 to perform integrated monitoring and diagnostic functions as described further herein. Fusion module 118 may be implemented via computer program code customizable for the varying needs of a business enterprise. For example, customizable features may include adjusting the length of time between data sampling, increasing or decreasing the number of alerts necessary before initiating a summary alert notice, determining a threshold value of a variable being monitored before triggering a summary alert, etc.

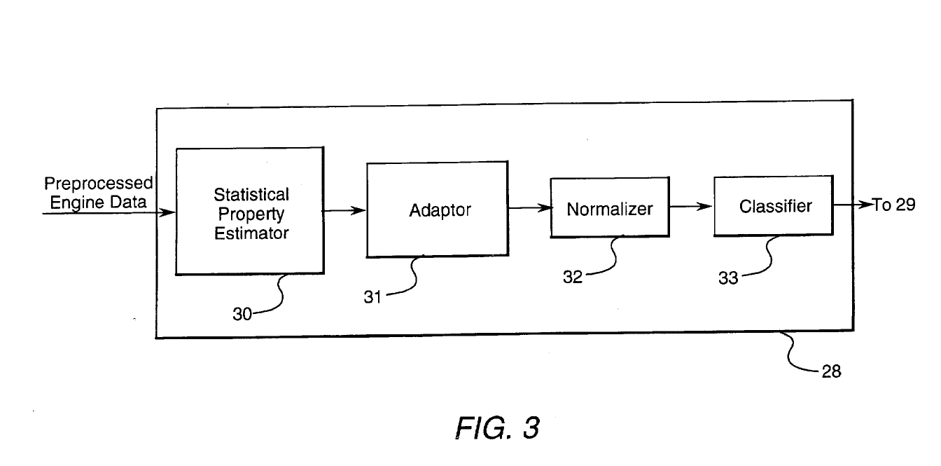

Summary alerts are generated by fusion module 118 and sent to remote client 106 when specified criteria are met. Summary alerts may contain processed raw data, general alert information from alerts 116, alert histories from alert knowledge database 126, and information received from fusion knowledge database 120. A sample summary alert 300 is illustrated in FIG. 3. Fusion module 118 also captures requests for additional information initiated by an end user as described further herein.

A call tracking feature 122 is provided by alert fusion system 110 and tracks requests for additional information received from fusion module 118 and receives resolution reports provided by an end user at remote client 106. A resolution report contains information relating to the problem subject to the summary alert as well as steps taken to resolve the problem, if applicable. Call tracking feature 122 processes the information and detects patterns of data requests from remote clients and classifies or categorizes the problem symptoms and resolutions received. Call tracking feature 122 is described in detail further herein.

Knowledge review system 124 periodically receives information from call tracking feature 122 and determines what procedural modifications or business process adjustments might be beneficial. For example, knowledge review system 124 may assess the most common or frequently occurring problems, the costliest problems to fix, and determine what additional information that should be made available to an end user for a given condition or problem. Knowledge review system 124 may recommend specific changes be made to the fusion knowledge database 120 or may implement the changes automatically, depending upon business rules adopted by the business enterprise. Knowledge review system 124 may also periodically assess the effectiveness of the information provided to alert knowledge database 126 and fusion knowledge database 120 by comparing the details provided in additional information requests and problem/resolution reports received from a database of call tracking feature 122. For example, if numerous problem/resolution reports continue to be generated for a specific equipment ID, knowledge review system 124 may determine that a remote engineer is not receiving technically accurate troubleshooting information from fusion knowledge database 120. These types of reviews enable knowledge review system 124 to continuously evaluate the usefulness of the respective knowledge bases.

Alert knowledge database 126 and fusion knowledge database 120 store updated information that has been processed via alert fusion system 110. For example, alert knowledge database 126 may store past alerts for a particular equipment variable, past alerts for all variables associated with a particular piece of equipment, and past alerts of neighboring equipment or equipment known to affect the performance of the problem equipment. Fusion knowledge database 120 may store possible causes of a particular problem, troubleshooting strategies, and collateral information demonstrated to be beneficial in assisting an end user in resolving a problem. Additional tools such as graphical and diagnostic tools may be accessible via alert fusion system 110 for assisting a remote client user in assessing and correcting a problem.

Components of alert fusion system 110 may be executed via one or more servers through which remote clients gain access to perform remote monitoring and diagnostics activities. Further these servers may include internal or external storage devices for housing alert knowledge database 126, fusion knowledge database 120, and information from call tracking feature 122. Remote clients can be directly connected to the server(s) or they could be coupled to the server via a network. The network may be any type of known network including a local area network (LAN), a wide area network (WAN), an intranet, or a global network (e.g., Internet). Remote clients may be coupled to the server through multiple networks so that not all remote clients are required to be coupled to the server through the same network. One or more of the remote clients and the server may be connected to the network in a wireless fashion and the network may be a wireless network. It will be understood that alert fusion system 110 can be implemented and maintained via a third party entity, such as an application service provider (ASP) under an agreement with one or more business enterprises, commercial entities, and/or non-commercial entities.

The storage device(s) may be implemented using a variety of devices for storing electronic information such as a file transfer protocol (FFP) server. It is understood that the storage device may be implemented using memory contained in the server(s) or it may be a separate physical device. The server may also operate as a database server and coordinate access to application data including data stored on the storage device. In an exemplary embodiment, the databases are initially populated by entering the information as monitoring and diagnostics are being carried out by end users. In an alternate exemplary embodiment, the databases are initially populated by importing data from an external system containing alerts files and diagnostics information stored on a legacy system.

An exemplary embodiment of a process for implementing alert fusion system 110 is described in FIG. 2. A series of alerts generated by monitor 104 are received by fusion module 118 at step 202. Fusion module 118 processes and prioritizes the alerts at step 204. Fusion module 118 contains instructions necessary to read the alert data received from monitor 104, classify and organize the alerts according to field equipment, sensors, and variables identified, and determine whether a summary alert should be created. Alerts are prioritized utilizing criteria established via alert knowledge database 126. For example, one or more variables being monitored for a specific piece of equipment may be flagged or otherwise rated as critical such that when sensor data indicate a condition detected, the corresponding alert may be slated for immediate action or review by an engineer via a summary alert. A severity threshold is established for each variable in assisting fusion module 118 in determining when it is appropriate to create and issue a summary alert.

If a severity threshold has not been reached at step 206, the process returns to step 204 whereby fusion module 118 continues to receive alerts and process them. If a severity threshold has been reached at step 206, fusion module 118 generates a summary alert and transmits it to a remote client 106 at step 208.

A sample summary alert 300 is illustrated in FIG. 3. Summary alert 300, presented as a computer screen window, illustrates detailed information relative to the condition detected as seen by an end user on remote client 106. Screen 300 includes information such as the equipment identification 302 subject to the alert, a sensor identification 304 for each sensor in which a problem has been detected along with a sensor reading 306. In this summary alert, the variable being monitored is temperature. An end user is presented with various options via summary alert 300. Options include ‘show alert history’ 308, ‘show fusion history’ 310, ‘additional information request’ 312, ‘troubleshooting’ 314, and ‘create resolution report’ 316.

The end user at remote client 106 evaluates the summary alert at step 210. If the end user would like to see a history of alerts for this sensor, the equipment associated with the sensor, and/or collateral equipment and sensors that affect the performance of the equipment being monitored, the ‘Show alert history’ 308 option is selected at step 212. Relevant alert history information retrieved from alert knowledge database 126 is presented to the end user. In an alternate embodiment, this information may be automatically displayed without a prompt from the end user. If desired, the end user requests more details from fusion knowledge database 120 at step 214.

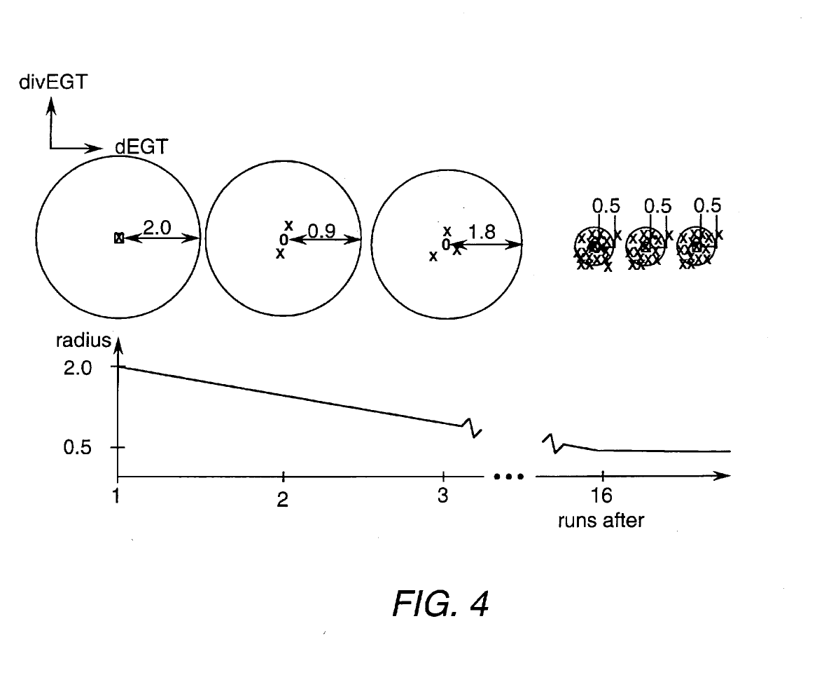

A sample fusion history screen 400 is shown in FIG. 4. Fusion history screen 400 provides general information 402 about the equipment/sensor subject to the summary alert with options 404 to select and view additional details for both the current summary alert and for previously issued summary alerts. An end user may also view graphs of data by selecting ‘show performance graph’ 406 and entering in a date 408 or date range 410. Fusion module 118 retrieves the data requested by the end user from one or both of fusion knowledge database 120 and alert knowledge database 126 and presents it to the end user at remote client 106.

The information received by the end user utilizing the ‘Show alert history’ 308 option, ‘Show fusion history’ 310 option, and ‘Additional information request’ 312 option provides additional insight on the circumstances surrounding the problem subject to the summary alert. For example, field equipment 102 is generating alerts on temperature and fusion module 118 generates and transmits a summary alert to remote client 106. The end user at remote client 106 realizes that it is a hot day, and desires to see a graph of the temperature sensor versus ambient temperatures or other temperature sensors in the same equipment or process. Likewise, the end user may want to check for another specific kind of alert or raw data value. Alert fusion system 110 provides this additional information to the end user. Upon evaluating the information, the end user may determine that the alert was false, or that a problem exists.

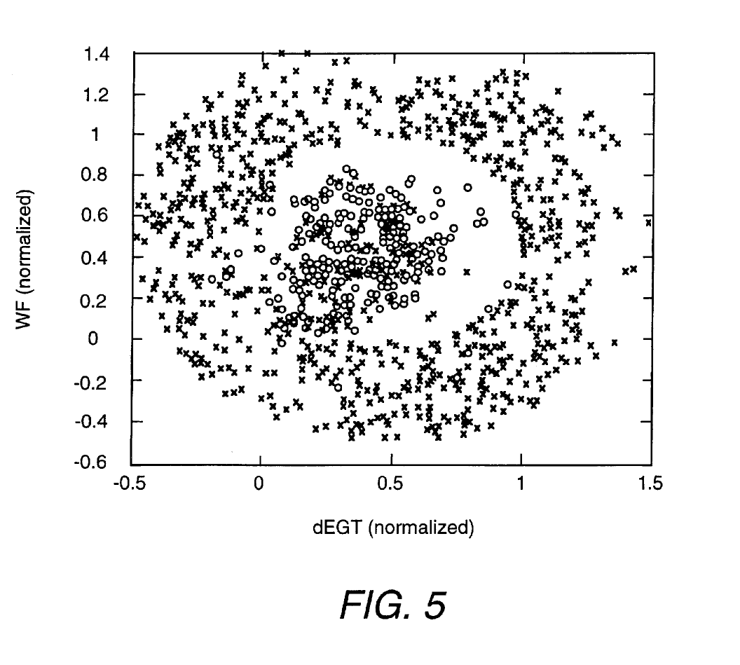

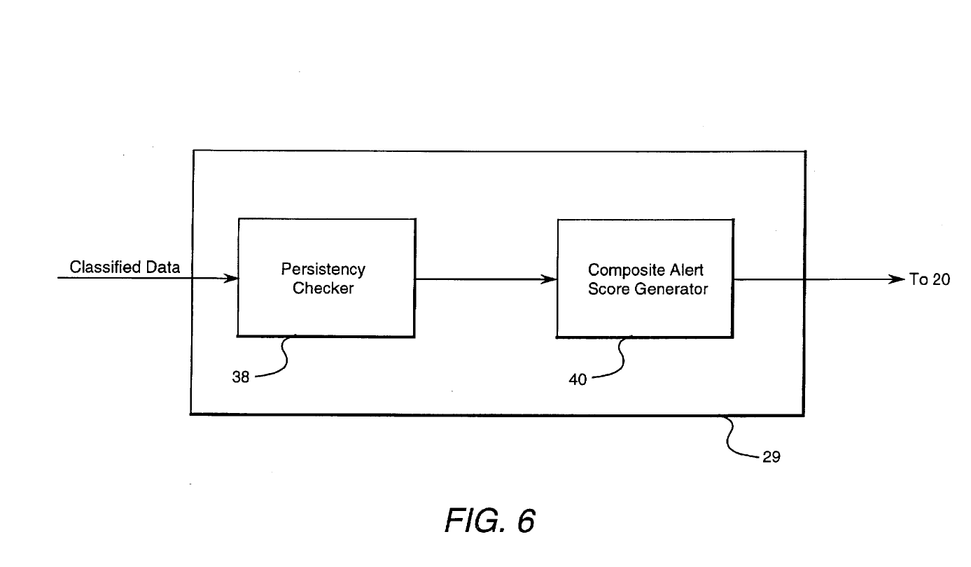

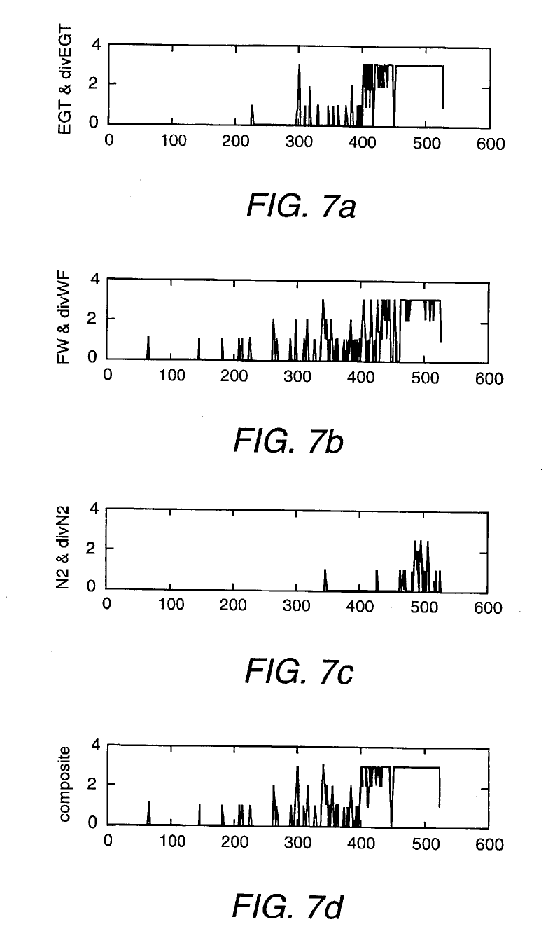

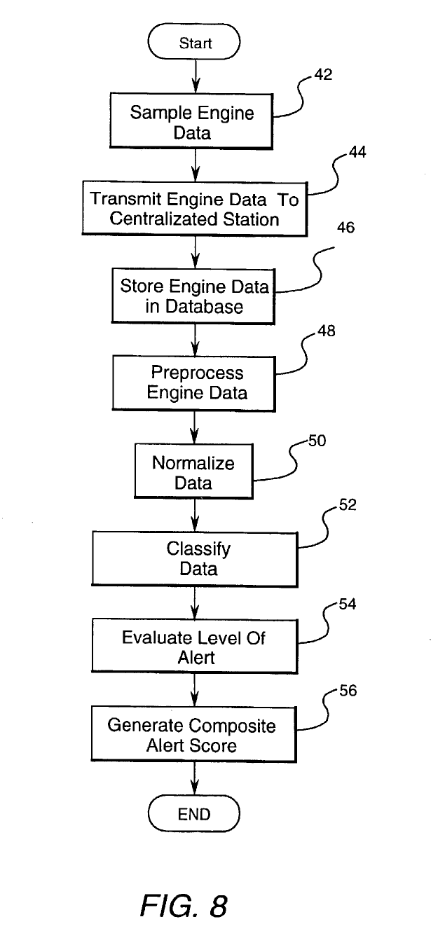

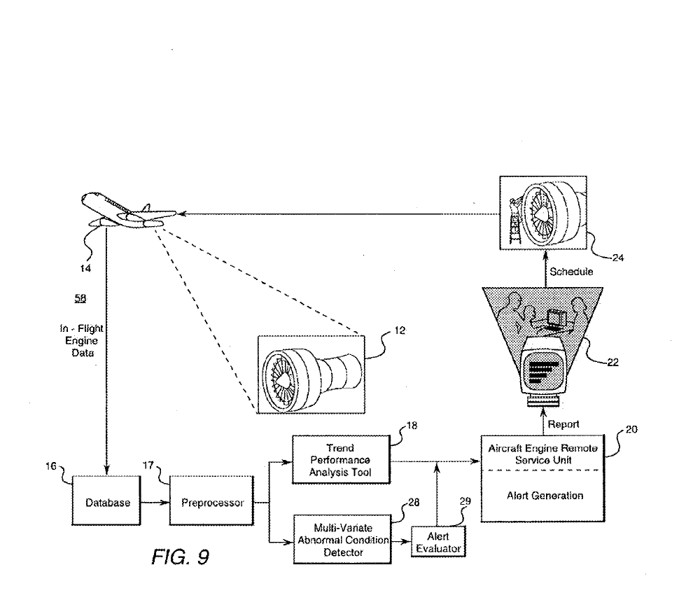

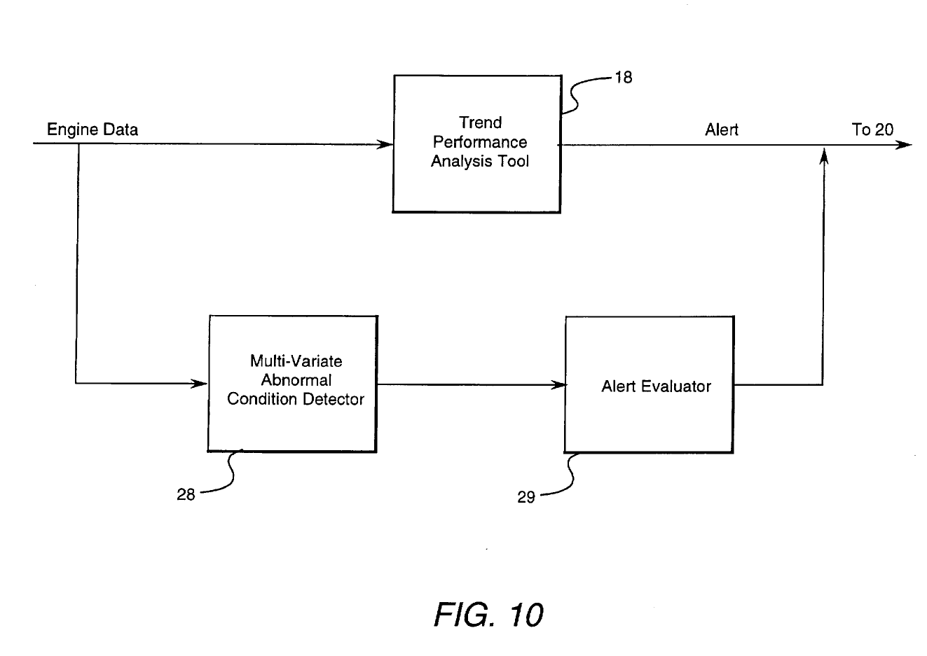

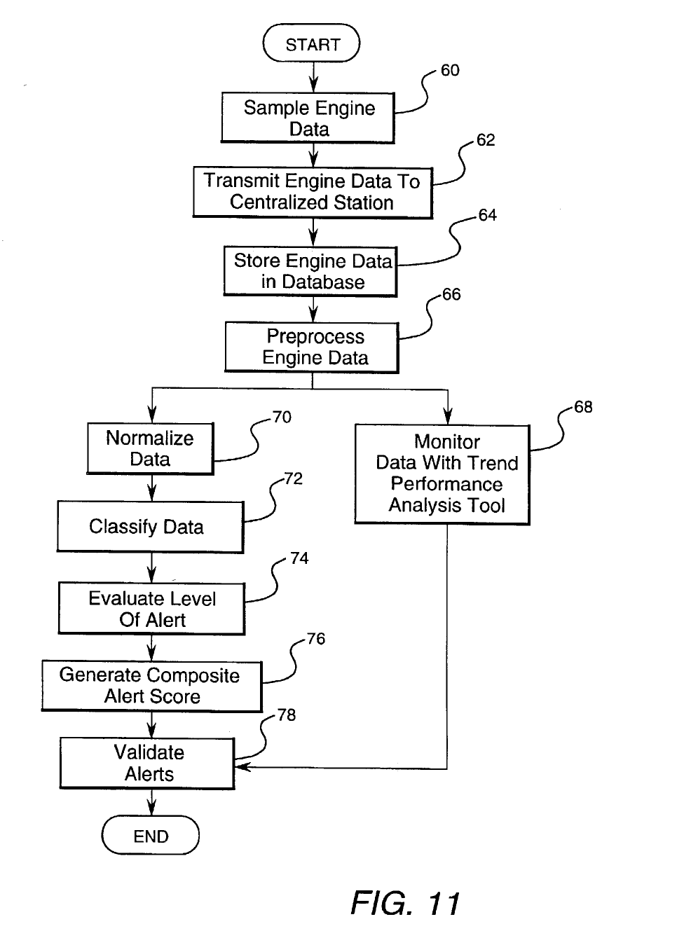

If the end user would like additional information not available via the ‘Show alert history’ 308 option or the ‘Show fusion history’ 310 option, he/she may select the ‘Additional information request’ 312 option, followed by entering a specific query. For example, an end user discovers that an inordinate number of field equipment instruments have been generating summary alerts over the last week. The end user may request additional information regarding the make and manufacture, lot number, age, etc. of these instruments. The response to this request may shed light on whether there is a defect in a batch or lot of instruments that were purchased or installed during the same time period. Also, the age of the instruments may be relevant, particularly if they have exceeded the expected lifespan. The requests entered via ‘Additional information request’ 312 option are captured by fusion module 118 and sent to call tracking feature 122. Once the end user has completed the evaluation of the summary alert, ‘troubleshooting’ 314 option may be selected whereby suggestions are provided for assisting the end user in resolving the problem. A sample troubleshooting screen 500 is shown in FIG. 5.

Fusion module 118 provides a user interface screen requesting that the end user enter specific information regarding the problem encountered at step 216 which is transmitted to call tracking feature 122. This function is accomplished by selecting ‘create resolution report’ 316 option on summary alert 300 screen.

The user interface screen also requests that the end user provide information regarding any resolutions for the problem at step 218. This may also be performed via the ‘create resolution report’ 316 option. The summary alert, end user requests for additional information, and problem/resolution information are transmitted to knowledge review system 124 for evaluation and/or processing and automatic database updates at step 220. The data is combined and processed at step 222. Using the above example, call knowledge review system 124 may suggest that fusion module 118 use ambient temperature to help decide whether to notify an engineer about other temperature alerts. It can also suggest that specific graphs or additional data be presented to the engineer along with the alert. It may also suggest that this type of alert is likely to lead to a particular diagnosis, based on the feedback the engineer entered via the call tracking feature 122. Depending upon the results of the evaluation, alert knowledge database 126 is updated at step 224 and/or fusion knowledge database 120 is updated at step 226, accordingly.

The alert fusion system allows engineers remotely monitoring equipment to access additional information with very little effort. By integrating alert generation with call tracking and diagnostics tools, the system is capable of collecting information with very little additional effort on the part of the engineer, resulting in higher quality data collection and facilitated knowledge capture. The alert fusion system can have significant applications in industries that utilize sensitive field equipment, and particularly those known to experience high failure rates. The alert fusion system is also capable of detecting and diagnosing events before they become problems.

As described above, the embodiments of the invention may be embodied in the form of computer-implemented processes and apparatuses for practicing those processes. Embodiments of the invention may also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. An embodiment of the invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another.

1. A method for building and maintaining a remote monitoring and diagnostics knowledge base via an alert fusion system, said method comprising:
receiving at least one alert from an equipment monitor, said at least one alert relating to a condition detected on field equipment being remotely monitored;
processing said at least one alert, said processing including evaluating a severity level;
if a severity threshold is reached, generating a summary alert; and
transmitting said summary alert to an end user at a remote client.

2. The method of claim 1, wherein said summary alert includes a ‘show alert history’ option.

3. The method of claim 1, wherein said summary alert includes a ‘show fusion history’ option.

4. The method of claim 1, wherein said summary alert includes an ‘additional information request’ option.

5. The method of claim 1, wherein said summary alert includes a ‘troubleshooting’ option.

6. The method of claim 2 wherein selecting said ‘show alert history’ option causes said alert fusion system to perform:
retrieving and transmitting to said end user past alerts relating to at least one of:
at least one sensor associated with said summary alert;
at least one field equipment device associated with said summary alert; and
at least one collateral equipment device associated with said summary alert, said collateral equipment device including equipment that affects performance of said field equipment being remotely monitored.

7. The method of claim 3, wherein selecting said ‘show fusion history’ option causes said alert fusion system to perform:
retrieving and transmitting to said end user:
information relating to at least one of a sensor and said field equipment device, said information including at least one of:
details of maintenance activities previously performed on said field equipment device; and
records of past summary alerts generated for said field equipment device; and
providing access to a graphical tool operable for generating performance graphs.

8. The method of claim 4, wherein selecting said ‘additional information request’ option causes said alert fusion system to perform:
transmitting a user interface screen with a text box to said end user, said text box operable for receiving a request for additional information from said end user;
upon receiving said request for additional information, retrieving and transmitting responsive information to said end user; and
transmitting said request for additional information and said responsive information to a ‘call tracking feature’ of said alert fusion system.

9. The method of claim 5, wherein selecting said ‘troubleshooting’ option causes said alert fusion system to perform:
providing suggested diagnostic activities operable for resolving a problem detected.

10. The method of claim 1, further comprising a ‘create resolution report’ option, wherein upon selecting said ‘create resolution report’ option said alert fusion system performs:
providing a user interface screen to said end user with instructions for assisting said end user in entering problem symptoms and resolution steps taken to correct a problem detected.

11. The method of claim 8, wherein said call tracking feature performs:
classifying data received in resolution reports, said request for additional information, and said responsive information for summary alerts;
detecting patterns of activity;
transmitting resulting data to a knowledge review system; and
updating said resulting data in at least one of:
said alert knowledge database; and
said fusion knowledge database.

12. The method of claim 11, wherein said patterns of activity include:
problem symptoms;
related field equipment devices experiencing similar symptoms;
field equipment devices sharing similar root causes;
location-based attributes; and
extraneous events including:
ambient temperature readings; and
precipitous events determined to have an impact on field equipment subject to said summary alert.

13. The method of claim 11, wherein said data is automatically updated in at least one of:
said alert knowledge database; and
said fusion knowledge database.

14. A storage medium encoded with machine-readable computer program code for building and maintaining a remote monitoring and diagnostics knowledge base via an alert fusion system, said storage medium including instructions for causing a computer to implement a method, comprising:
receiving at least one alert from an equipment monitor, said at least one alert relating to a condition detected on field equipment being remotely monitored;
processing said at least one alert, said processing including evaluating a severity level;
if a severity threshold is reached, generating a summary alert; and
transmitting said summary alert to an end user at a remote client.

15. The storage medium of claim 14, wherein said summary alert includes a ‘show alert history’ option.

16. The storage medium of claim 14, where in said summary alert includes a ‘show fusion history’ option.

17. The storage medium of claim 14, wherein said summary alert includes an ‘additional information request’ option.

18. The storage medium of claim 14, wherein said summary alert includes a ‘troubleshooting’ option.

19. The storage medium of claim 15 wherein selecting said ‘show alert history’ option causes said alert fusion system to perform:
retrieving and transmitting to said end user past alerts relating to at least one of:
at least one sensor associated with said summary alert;
at least one field equipment device associated with said summary alert; and
at least one collateral equipment device associated with said summary alert, said collateral equipment device including equipment that affects performance of said field equipment being remotely monitored.

20. The storage medium of claim 16, wherein selecting said ‘show fusion history’ option causes said alert fusion system to perform:
retrieving and transmitting to said end user:
information relating to at least one of a sensor and said field equipment device, said information including at least one of:
details of maintenance activities previously performed on said equipment device; and
records of past summary alerts generated for said field equipment device; and providing access to a graphical tool operable for generating performance graphs.

21. The storage medium of claim 17, wherein selecting said ‘additional information request’ option causes said alert fusion system to perform:
transmitting a user interface screen with a text box to said end user, said text box operable for receiving a request for additional information from said end user;
upon receiving said request for additional information, retrieving and transmitting responsive information to said end user; and
transmitting said request for additional information and said responsive information to a ‘call tracking feature’ of said alert fusion system.

22. The storage medium of claim 18, wherein selecting said ‘troubleshooting’ option causes said alert fusion system to perform:
providing suggested diagnostic activities operable for resolving a problem detected.

23. The storage medium of claim 14, further comprising instructions for causing said computer to ‘create resolution report’ option, wherein upon selecting said ‘create resolution report’ option said alert fusion system performs:
providing a user interface screen to said end user with instructions for assisting said end user in entering problem symptoms and resolution steps taken to correct a problem detected.

24. The storage medium of claim 21, wherein said call tracking feature performs:
classifying data received in resolution reports, said request for additional information, and said responsive information for summary alerts;
detecting patterns of activity;
transmitting resulting data to a knowledge review system; and
updating said resulting data in at least one of:
said alert knowledge database; and
said fusion knowledge database.

25. The storage medium of claim 24, wherein said patterns of activity include:
problem symptoms;
related field equipment devices experiencing similar symptoms;
field equipment devices sharing similar root causes;
location-based attributes; and
extraneous events including:
ambient temperature readings; and
precipitous events determined to have an impact on field equipment subject to said summary alert.

26. The storage medium of claim 24, wherein said data is automatically updated in at least one of:
said alert knowledge database; and
said fusion knowledge database.

27. A system for building and maintaining a remote monitoring and diagnostics knowledge base comprising:
at least one field equipment device;
a remote client in communication with said at least one field equipment device;
an alert fusion system in communication with said at least one field equipment device and said remote client; and
a summary alert generated via said alert fusion system.

28. The system of claim 27, wherein said alert fusion system comprises:
a monitor operable for receiving raw data and signals from said at least one field equipment device;
a fusion module;
an alert knowledge database;
a fusion knowledge database; and
a knowledge review system.

29. The system of claim 28, further comprising a call tracking feature, said call tracking feature including:
requests for additional information in response to receiving a summary alert;
resolution reports comprising problem symptoms and problem resolutions for correcting said problem symptoms;
a means for detecting patterns of said problem symptoms in said resolution reports;
a means for categorizing said patterns of problem symptoms in said resolution reports; and
a means for categorizing problem resolutions in said resolution reports.

30. The system of claim 27, wherein said summary alert comprises at least one of:
raw data from said monitor;
alert data provided via said monitor;
alert history data;
fusion history data;
graphical data;
a means for requesting additional information; and
a means for reporting problem data and resolution data.

31. The system of claim 28, wherein said fusion module processes and prioritizes alerts received via said at least one field equipment device.

32. The system of claim 28, wherein said alert knowledge database stores:
past alerts; and
business rules and policy information operable for performing at least one of:
determining when to issue an alert; and
establishing parameter limits for variables being monitored.

33. The system of claim 28, wherein said fusion knowledge database stores:
past and present summary alerts;
troubleshooting information; and
graphical performance data for said at least one field equipment device.

34. The system of claim 28, wherein said knowledge review system comprises:
a means for evaluating the effectiveness of information stored in said alert knowledge database; and
a means for evaluating the effectiveness of information stored in said fusion knowledge database.

35. The system of claim 29, wherein said call tracking feature transmits said resolution reports and said requests for additional information to said knowledge review system, wherein said resolution reports and said requests for additional information are analyzed by said knowledge review system resulting in modifications and updates to said alert knowledge database and said fusion knowledge database.

36. The system of claim 27, wherein said remote client is a web-enabled computer processor device.

37. The system of claim 27, wherein said field equipment, said alert fusion system, and said remote client are in communication via a computer network.
